(19) United States
(12) Patent Application Publication
(10) Pub. No.: US 2026/0245181 A1
(43) Pub. Date: Aug. 20, 2026

(54) PERFORMING DEFECT-FREE IMAGE RECONSTRUCTION USING ARTIFICIAL INTELLIGENCE

(71) Applicant: GE Precision Healthcare LLC, Waukesha, WI (US)

(72) Inventors: Hongxu Yang, Helmond, Noord-Brabant (NL); Gopal Avinash, Concord, CA (US); Lehel Mihály Ferenczi, Budapest (HU); Xiaomeng Dong, Bellevue, WA (US)

(73) Assignee: GE Precision Healthcare LLC, Waukesha, WI (US)

(21) Appl. No.: 19/057,917

(22) Filed: Feb. 19, 2025

(51) Int. Cl. G06T 5/60; G06T 7/00; G06T 11/00

(52) U.S. Cl. CPC G06T 5/60; G06T 7/0012; G06T 12/20; G06T 2207/10081; G06T 2207/10088; G06T 2207/10104; G06T 2207/10108; G06T 2207/10132; G06T 2207/20081; G06T 2207/20084; G06T 2207/30004; G06T 2210/41; G06T 2211/441; G06T 2211/448

(57) ABSTRACT

Systems and methods for performing defect-free image reconstruction using artificial intelligence are described herein. In one example, a system configured to train an artificial intelligence model includes a processing circuit having a processor coupled to a memory device. The memory device stores instructions thereon that, when executed, cause the processing circuit to perform operations including identifying a cause of an abnormality within image data; generating synthetic data based on the cause of the abnormality; training the artificial intelligence model using the synthetic data; and performing, using the artificial intelligence model, reconstruction of the image data.

### FIELD

Embodiments of the subject matter disclosed herein relate to medical imaging, and more particularly, to performing defect-free image reconstruction using artificial intelligence.

### BACKGROUND

During a medical imaging process, a plurality of medical images of a patient are obtained by a technician to measure or detect various aspects of anatomical features present within the medical images. Various factors regarding the medical imaging process can contribute to a resulting image quality of the plurality of medical images such as system hardware, system software, or patient-related variables.

### SUMMARY

An embodiment relates to a system configured to train an artificial intelligence model. The system includes a processing circuit comprising a processor coupled to a memory device storing instructions thereon that, when executed, cause the processing circuit to perform operations including identifying a cause of an abnormality within image data; generating synthetic data based on the cause of the abnormality; training the artificial intelligence model using the synthetic data; and performing, using the artificial intelligence model, reconstruction of the image data.

Another embodiment relates to a medical imaging system including an imaging unit and a processing circuit having a processor coupled to a memory device storing instructions thereon that, when executed, cause the processing circuit to perform operations. The operations include receiving image data of a subject, the image data obtained using the imaging unit. The operations include identifying an abnormality within the image data. The operations include determining a cause of the abnormality within the image data. The operations include correcting, using an artificial intelligence model, the abnormality based on the cause of the abnormality. The artificial intelligence model is configured to correct for abnormalities within the image data that are respectively caused by one or more hardware components, by one or more software components, and by the subject.

Another embodiment relates to a method for performing medical image reconstruction. The method includes receiving, by a processing circuit of a medical imaging system, image data obtained using the medical imaging system. The method includes identifying, by the processing circuit, an abnormality within the image data. The method includes determining, by the processing circuit, a cause of the abnormality within the image data. The method includes correcting, by the processing circuit using an artificial intelligence model, the abnormality based on the cause of the abnormality, where the artificial intelligence model is configured to correct for abnormalities within the image data that are respectively caused by one or more hardware components, by one or more software components, and by a subject. The method includes reconstructing an output image based on the image data with the corrected abnormality.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a block diagram of a medical imaging system, according to an example embodiment.

FIG. 2 is a flow chart illustrating a method for performing defect-free image reconstruction using the medical imaging system of FIG. 1, according to an example embodiment.

FIG. 3 is a diagram illustrating identification of defects and artifacts during the method of FIG. 2 in greater detail, according to an example embodiment.

FIG. 4A is a sinogram depicting a hardware-caused defect, according to an example embodiment.

FIG. 4B is a computed tomography (CT) image depicting the hardware-caused defect of FIG. 4A, according to an example embodiment.

FIG. 5A is another sinogram depicting another hardware-caused defect, according to an example embodiment.

FIG. 5B is a CT image depicting the hardware-caused defect of FIG. 5A, according to an example embodiment.

FIG. 5C is a first image of a simulated data pair configured to resolve the hardware-caused defect of FIG. 5A, according to an example embodiment.

FIG. 5D is a second image of the simulated data pair configured to resolve the hardware-caused defect of FIG. 5A, according to an example embodiment.

FIG. 6 is a series of simulated CT images depicting a software- and patient-caused defect, according to an example embodiment.

FIG. 7A is a positron emission tomography (PET) image depicting a hardware- and patient-caused defect, according to an example embodiment.

FIG. 7B is a PET image correcting for the hardware- and patient-caused defect of FIG. 7A, according to an example embodiment.

FIG. 7C is a single-photon emission computerized tomography (SPECT) image depicting a hardware- and patient-caused defect, according to an example embodiment.

FIG. 7D is a SPECT image correcting for the hardware- and patient-caused defect of FIG. 7C, according to an example embodiment.

FIG. 8 is a diagram illustrating an artificial intelligence (AI) model configured to perform defect-free image reconstruction, according to an example embodiment.

### DETAILED DESCRIPTION

Referring generally to the figures, systems and methods for performing defect-free image reconstruction are disclosed. More specifically, the systems and methods described herein include implementing an artificial intelligence (AI) model configured to resolve defects, artifacts, abnormalities, and so on, within medical image data that are caused by hardware components of a medical imaging system, software components of a medical imaging system, and patient-related variables. In other words, the AI model used to correct for defects and perform image reconstruction, as described herein, is designed and trained such that the AI model is foundationally generalized to all possible artifacts that may be present within the image data. In other words, the AI model described herein is robust to a variety of factors that may cause the defects, artifacts, abnormalities, and so on, within the medical image data.

In existing medical imaging systems, hardware and software limitations of the systems often result in defects or artifacts within medical image data. For example, an imaging unit (e.g., a scanner) used to perform a medical imaging procedure (e.g., magnetic resonance (MR) imaging, computed tomography (CT), ultrasound, X-ray, etc.) has a detector unit that may become defective due to broken or otherwise malfunctioned hardware, which results in the medical image data having artifacts or a compromised image quality. As another example, software algorithmic limitations during a CT imaging or MR imaging result in artifacts or a compromised image quality due to sinogram or k-space discontinuity caused by metal being present in the patient's body, among other reasons. Thus, the medical image data generated by existing medical imaging systems are subject to defects, artifacts, abnormalities, and so on, that are caused by a number of factors such as hardware components, software components, patient-related variables, and post-processing techniques.

The systems and methods described herein, however, provide a technical solution to existing systems by providing a foundational AI model configured to perform defect-free image reconstruction. More specifically, the solution described herein implements AI techniques (e.g., unrolled dual-domain model, non-unrolled signal domain model, etc.) and synthetic data generation, which facilitate the problem definition, data synthesis, and model design or development described herein. That is, the systems and methods described herein aim to reduce image quality reduction factors by designing a model from synthetic data generation to model training.

Furthermore, the systems and methods described herein provide an AI-based solution concerning a plurality of scanning defects. For instance, the AI model described herein is configured to resolve defects caused by hardware devices, software reconstruction algorithms, and materials or other substances applied to a patient's body during an imaging procedure (fluid factors, contrast agent dose, etc.). The systems and methods described herein are then configured to address image defects such as artifacts, noise, or compromised resolution due to various reasons. Thus, the systems and methods described herein are configured to realize generation of synthetic data pairs from principal definitions in hardware, software, human anatomy, or other categories. The synthetically generated data pairs include an image domain and a scanning domain, which is suitable for AI-based iterative dual-domain optimization methods. Therefore, hardware-based and software-based limitations in both domains (e.g., the image domain and the scanning domain) can be defined during training and model design. Such an approach results in improved model performance, speed, and inference footprint when addressing variously caused defects at once. Additionally or alternatively, the model may be trained using synthetic data in one of the image domain or the scanning domain, thus facilitating a more generalized training of the model than in the dual-domain methods.

The implementations described herein address a technical problem by providing enhanced data integration and analysis capabilities, which deliver a particular technical solution that streamlines and refines generation and transmittal of medical images. More specifically, the systems and methods described herein provide a systematic method of generating an AI model applicable in cases of defective image data caused by a variety of factors such as hardware malfunctions, software malfunctions, and/or patient-related variables. Accordingly, this approach provides a specific technical improvement to various technical problems, including those set forth herein.

The systems described herein may also reduce processing power by performing various processing operations simultaneously, rather than performing a plurality of processing operations individually and consuming unnecessary processing power. That is, the systems and methods described herein result in more efficient model development and improved model performance.

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

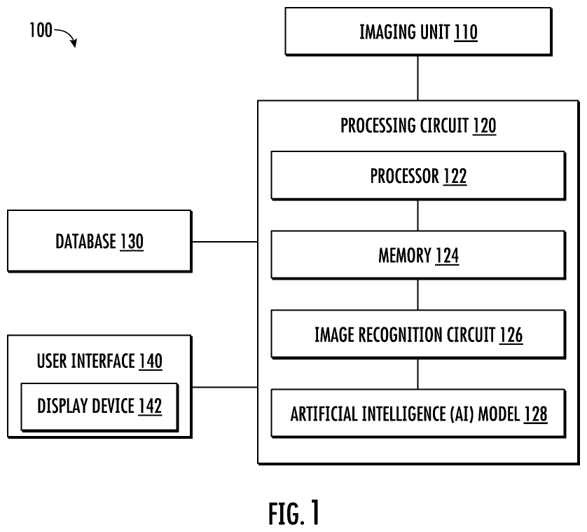

Referring to FIG. 1, a schematic diagram of a medical imaging system 100 is shown. The medical imaging system 100 may be used in a medical environment (e.g., hospitals, clinics, etc.), for example, by a sonographer, radiographer, technician, or other clinician certified to collect medical image data of a patient. It should be appreciated that the medical imaging system 100 described herein may refer to any of a variety of medical imaging systems (e.g., a computed tomography (CT) imaging system, an ultrasound imaging system, a magnetic resonance (MR) imaging system, a positron emission tomography (PET) imaging system, a single-photon emission computerized tomography (SPECT) imaging system, etc.).

For instance, a CT imaging system uses X-rays to generate cross-sectional images of the body. More specifically, an imaging unit (e.g., imaging unit 110) used in the CT imaging system includes an X-ray source positioned around the patient that emits a narrow beam of X-rays through the body from multiple angles. The imaging unit also includes detectors configured to capture the transmitted X-rays that pass through different features (e.g., tissues) in the body, each of the different features absorbing the radiation to varying degrees depending on their density and composition. These signals are then processed by the system to reconstruct a series of two-dimensional slices, which can be stacked to create a three-dimensional representation of the imaged area.

An ultrasound imaging system, as another example, uses high-frequency sound waves to create real-time images of structures inside the body. More specifically, a transducer (e.g., a handheld device) generates the sound waves and directs them into the body. As the sound waves encounter different tissues, they are reflected back to the transducer as echoes at varying intensities based on the density and composition of the tissues. The transducer then converts the echoes into electrical signals, which are processed by the system to produce images displayed on a monitor. Ultrasound is non-invasive, radiation-free, and widely used for various applications, including monitoring pregnancies and examining organs.

An MR imaging system uses magnetic fields and radio waves to create detailed images of the body's internal structures. An MR system first generates a magnetic field that aligns the protons in the hydrogen atoms of the body's tissues. A series of radiofrequency pulses are then applied, causing the protons to absorb energy and shift their alignment. When the pulses stop, the protons release the energy as they return to their original state. The MR imaging system detects and processes these signals to create detailed images, differentiating between various tissue types based on their water content and chemical composition. MR may be used for imaging soft tissues, such as the brain, muscles, and organs, without exposing patients to ionizing radiation.

PET imaging systems are configured to detect gamma rays emitted from a radioactive tracer that is injected into the patient's body. The tracer (e.g., a compound such as glucose labeled with a radioactive isotope) accumulates in areas of high metabolic activity, such as rapidly growing tumors or active brain regions. As the radioactive isotope decays, it emits positrons that collide with electrons in the body, resulting in the emission of two gamma rays traveling in opposite directions. The PET imaging unit detects these gamma rays with a ring of specialized detectors, and the data is processed to reconstruct three-dimensional images, which provide detailed information about the body's biochemical and metabolic processes. In this way, PET imaging systems may be used in oncology, cardiology, and neurology for diagnosing diseases, monitoring treatments, and studying brain function.

Similarly, SPECT imaging systems are also configured to detect gamma rays emitted from a radioactive tracer introduced into the patient's body. The tracer is attached to a molecule that targets specific organs or tissues and emits gamma photons as it decays. An imaging unit in the SPECT imaging systems is equipped with one or more gamma cameras that rotate around the patient and captures the photons from different angles. The system uses the detected signals to reconstruct three-dimensional images of the tracer distribution within the body, showing functional information about organs and tissues. In this way, SPECT imaging systems may be used for assessing blood flow, cardiac function, and bone metabolism, as well as diagnosing conditions such as cancer, infections, and neurological disorders.

Using the MR imaging system as an example, an imaging procedure performing using the medical imaging system 100 may be performed as described in the following. During the procedure, the patient lies on a motorized table that slides into a large, cylindrical imaging unit (e.g., scanner) equipped with magnets. To receive clear images, the patient remains as still as possible throughout the scan. Depending on the area being examined, a contrast agent may be injected into the patient's bloodstream to enhance visibility of certain tissues or blood vessels. The MR imaging system creates the magnetic field and emits radiofrequency pulses, which interact with hydrogen atoms in the patient's body. These interactions generate signals that are processed by the system to produce detailed images of the targeted area. As described above, the MR imaging procedure may be used to diagnose and monitor a wide range of medical conditions such as brain disorders, joint injuries, and tumors.

As shown in FIG. 1, the medical imaging system 100 includes an imaging unit 110, a processing circuit 120, a database 130, and a user interface 140. The imaging unit 110 refers to a device or mechanism configured to obtain image data during a medical imaging procedure using the medical imaging system 100. That is, the imaging unit 110 may include any of a device or a mechanism used to obtain image data during a CT imaging procedure, an ultrasound imaging procedure, an MR imaging procedure, a PET imaging procedure, a SPECT imaging procedure, etc., depending on an implementation of the medical imaging system 100.

Referring still to FIG. 1, the processing circuit 120 is shown to include at least one processor 122, a memory 124, an image recognition circuit 126, and an artificial intelligence (AI) model 128. In this way, the processing circuit 120 may be structured or configured to execute or implement the instructions, commands, and control processes described herein with respect to the processor 122, the memory 124, the image recognition circuit 126, and the AI model 128. While shown as being separate from the imaging unit 110 in FIG. 1, it will be appreciated that the processing circuit 120 can be part of the imaging unit 110. For example, the processing circuit 120 can be disposed in a handheld housing of a probe (e.g., in the case of the imaging unit 110 being a wireless probe).

The processor 122 may include a CPU, a GPU, a microprocessor, a DSP, a general-purpose single- or multi-chip processor, a field-programmable gate array (FPGA), or any other type of processor capable of performing logical operations. A general-purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the processor 122 may be shared by multiple circuits (e.g., the circuits of the processor 122 may include or otherwise share the same processor which, in some example embodiments, may execute instructions stored, or otherwise accessed, via different areas of the memory 124). Alternatively or additionally, the processor 122 may be structured to perform or otherwise execute certain operations independent of one or more co-processors. In some embodiments, two or more processors may be coupled via a bus to enable independent, parallel, pipelined, or multi-threaded instruction execution. All such variations are intended to fall within the scope of the present disclosure.

The processor 122 may also be in electronic communication with the imaging unit 110. For purposes of this disclosure, the term “electronic communication” may be defined to include both wired and wireless communications. In some embodiments, the processor 122 may be configured to control the imaging unit 110 during data acquisition. The processor 122 may also be in electronic communication with a display device (e.g., display device 142) such that the processor 122 may process ultrasound data obtained by the imaging unit 110 and generate images to display on the display device. Further, in some embodiments, the medical imaging system 100 may include multiple processors configured to perform the processing operations and functionality described with reference to processor 122.

As shown in FIG. 1, the processing circuit 120 also includes the memory 124. The memory 124 may be configured to, for example, store processed volumes of data obtained by the medical imaging system 100 (e.g., image data collected by the imaging unit 110, user inputs received via user interface 140, etc.). For example, the memory 124 may be a hospital picture archiving and communication system (PACS). The memory 124 (e.g., memory, memory unit, storage device, etc.) may include one or more devices (e.g., RAM, ROM, Flash memory, hard disk storage, etc.) for storing data and computer code for completing or facilitating the processes, layers, and modules described in the present application. The memory 124 may be or include tangible, non-transient volatile memory or non-volatile memory. The memory 124 may also include database components, object code components, script components, or any other type of information structure for supporting the activities and information structures described in the present application.

The processing circuit 120 is also shown to include the image recognition circuit 126 and the AI model 128. The image recognition circuit 126 and the AI model 128 are configured to facilitate defect-free image reconstruction, as described herein.

The image recognition circuit 126 is configured to receive image data obtained by the imaging unit 110 during a medical imaging procedure. More specifically, the image recognition circuit 126 may include multiple deep learning-based models configured to analyze the image data. For example, image recognition circuit 126 may be configured to identify a view from which the image data is captured, an anatomical structure or other feature captured by the image data, the presence of a defect/artifact in the image data, and so on. The image recognition circuit 126 may be configured to identify the anatomical structure using one or more algorithms (e.g., image processing algorithms such as edge detection, machine learning models, deep neural networks, etc.). In some embodiments, the image recognition circuit 126 may identify anatomical features such as bones, blood vessels, organs, etc., based on a shape, relative proximity, apparent depth, orientation, etc. of said features in the image data.

As described in greater detail herein, the AI model 128 may be an unrolled AI model. As described below, the AI model 128 may be configured to correct for abnormalities within image data that are respectively caused by one or more hardware components (e.g., of the medical imaging system 100), by one or more software components (e.g., of the medical imaging system 100), and by a subject (e.g., of a medical imaging procedure performed using the medical imaging system 100). More specifically, the unrolled AI model may be a dual-domain AI model configured to correct for the abnormalities using training data pairs corresponding to an imaging unit domain (e.g., sinogram or K-space) and an image domain.

An unrolled AI model refers to a representation of an iterative or recurrent process, such as those in recurrent neural networks (RNNs) or optimization algorithms, where the operations are expanded across a sequence of steps. For example, in an RNN, the network processes sequential data by repeatedly applying the same set of weights at each time step. Unrolling this network means representing it as a series of layers, each corresponding to a single time step, effectively converting it into a feedforward architecture. Similarly, in optimization tasks, iterative algorithms such as gradient descent can be “unrolled” into a neural network where each iteration forms a layer, and parameters are learned from data rather than being fixed.

As shown in FIG. 1, the medical imaging system 100 may also include a database 130 and a user interface 140. The database 130 refers to a database from which the processing circuit 120 (e.g., the AI model 128) may retrieve information used to perform defect-free image reconstruction, as described herein. In some embodiments, the database 130 may include historical information relating to the medical imaging system 100. Additionally or alternatively, the database 130 may include information relating to physical, chemical, mathematical, and biological principles. In this way, the information included in the database 130 may be used to identify a cause of image defects or artifacts (e.g., at step 210 of method 200, as described below) and for generation of training data pairs (e.g., at step 215 of method 200, as described below).

The user interface 140 may be used by a technician to control operation of the medical imaging system 100. For example, the technician may use the user interface 140 to control the input of patient data, to change a scanning or display parameter, and/or to select various other modes, operations, parameters, etc. of the medical imaging system 100. In some embodiments, the user interface 140 may include an off-the-shelf consumer electronic device such as a smartphone, a tablet, a laptop, and so on. For the purposes of this disclosure, the term “off-the-shelf consumer electronic device” is defined to be an electronic device that was designed and developed for general consumer use and one that was not specifically designed for use in a medical environment. Alternatively, in other embodiments, the user interface 140 may be an electronic device that was designed and developed for use in a medical environment.

According to some embodiments, the user interface 140 may be physically separate from the rest of the medical imaging system 100 (e.g., the imaging unit 110, the processing circuit 120, and/or the database 130). The user interface 140 may communicate with the processor 122 through a wireless protocol, such as Wi-Fi, Bluetooth, wireless local area network (WLAN), near-field communication, and so on. According to some embodiments, the user interface 140 may communicate with the processor 122 through an application programming interface (API).

In some embodiments, the user interface 140 may include physical controls such as one or more of buttons, sliders, a rotary knob, a mouse, a keyboard, a trackball, hard keys linked to specific actions, soft keys that may be configured to control different functions, and so on. As shown in FIG. 1, the user interface 140 may also include a display device 142. In some embodiments, the display device 142 may be configured to display a graphical user interface (GUI) based on an instruction from the memory 124. The GUI may include user interface icons representing commands and instructions relating to the operation of the medical imaging system 100. The user interface icons of the GUI may be configured such that a user (e.g., technician, clinician, etc.) may select a specific user interface icon in order to initiate a specific function controlled by the GUI. For example, various user interface icons may be used to represent windows, menus, buttons, cursors, scroll bars, and so on. That is, the physical controls of the user interface 140 may be included as individual hardware elements, as user interface icons displayed on the display device 142, or as a combination of hardware elements and user interface icons.

In some embodiments, the display device 142 may include a touch-sensitive display device or a touch screen. According to such embodiments, the touch screen may be configured to interact with the GUI displayed by the display device 142 such that a user (e.g., the technician) can interact with the GUI via the touch screen. The touch screen may be a single-point touch screen that is configured to detect a single contact point at a time, or the touch screen may be a multi-point touch screen that is configured to detect multiple points of contact at a time. For embodiments where the touch screen is a multi-point touch screen, the touch screen may be configured to detect multi-point gestures involving contact from two or more of a user's fingers at a time. The touch screen may be a resistive touch screen, a capacitive touch screen, or any other type of touch screen that is configured to receive inputs from a stylus or one or more of a user's fingers. According to some embodiments, the touch screen may be an optical touch screen that uses technology such as infrared light or other frequencies of light to detect one or more points of contact initiated by a user. In some embodiments, the touch screen may be incorporated as part of the display device 142 or may be separate from the display device 142.

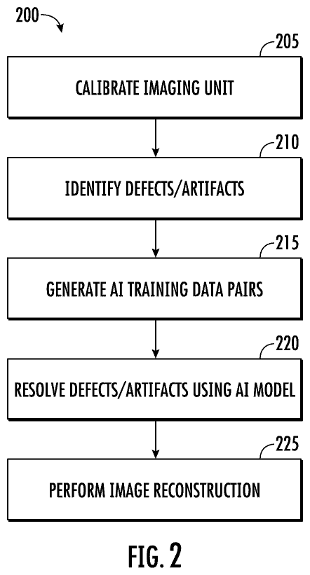

Referring to FIG. 2, a flow chart illustrating a method 200 for performing defect-free image reconstruction using a medical imaging system is shown. In at least one embodiment, the medical imaging system referred to by method 200 is the medical imaging system 100 described above with reference to FIG. 1, and method 200 may be implemented by the medical imaging system 100. In some embodiments, method 200 may be implemented as executable instructions in a memory of the medical imaging system 100, such as the memory 124 of FIG. 1.

As shown in FIG. 2, method 200 may include calibrating the imaging unit 110 at step 205. In some instances, step 205 may further include receiving image data of a subject (e.g., obtained using the imaging unit 110). For example, at step 205, the method 200 may include receiving medical image data obtained from one of a CT imaging system, an ultrasound imaging system, a MR imaging system, a PET imaging system, a SPECT imaging system, among other medical imaging systems.

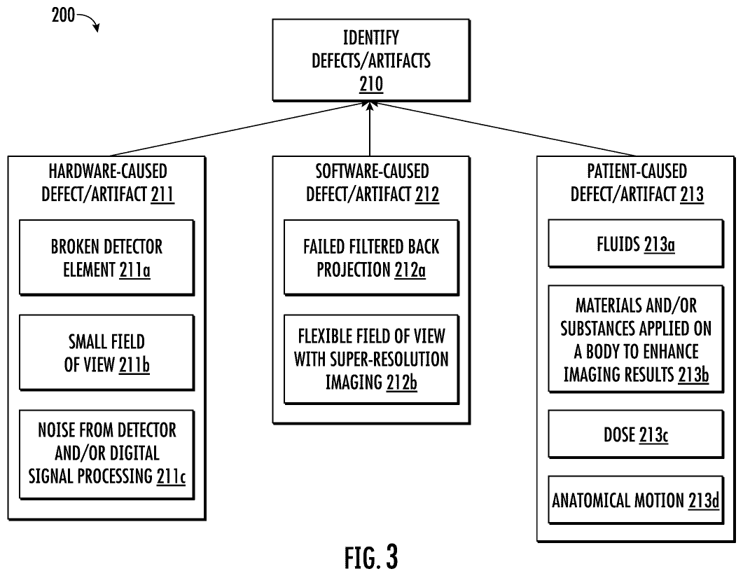

At step 210, one or more abnormalities (e.g., defects, artifacts) may be identified from image data obtained using the imaging unit 110 after being calibrated at step 205. More specifically, the one or more abnormalities may include artifacts, noise, a low-resolution, or a reduced field of view in the image data. As described in greater detail with reference to FIG. 3, step 210 may include identifying a cause of the abnormality from the image data. For instance, step 210 may include determining whether the abnormality is caused by hardware-related factors, software-related factors, or patient-related factors. In some instances, the cause of the abnormality may be one of the hardware-related factors, software-related factors, or patient-related factors. Additionally or alternatively, the cause of the abnormality may be any combination of hardware-related factors, software-related factors, and/or patient-related factors. In this way, the medical imaging system 100 may be configured to define a forward problem (e.g., y=f(x), as described in greater detail below) using the cause(s) of the abnormality the determined at step 210.

After identifying the abnormality at step 210, method 200 may include generating AI training data pairs at step 215. That is, once the forward problem is defined at step 210 (e.g., after identifying the cause(s) of the abnormality), the medical imaging system 100 may be configured to generate AI training data. In some instances, physical, chemical, mathematical, and/or biological principles may be used to generate the AI training data pairs at step 210. For example, the physical, chemical, mathematical, and/or biological principles may be retrieved from the database 130. Additionally or alternatively, in some embodiments, the AI training data pairs may include actual clinical data, natural images, synthetic images, and so on. The training data pairs are generated at step 215 based on the forward problem defined at step 210 such that the training data pairs include pixel-to-pixel accurate training data with the desired properties to recover in the scanning domain and the image domain. Furthermore, the training data pairs generated at step 215 correspond to an imaging unit domain (e.g., sinogram or K-space) and an image domain. Advantageously, with the defined forward problem, the synthetic data generation can be controlled to vary parameters as desired based on the identified abnormalities.

At step 220, the abnormalities identified at step 210 may be corrected or resolved using the AI model 128. That is, the synthetic data generated at step 215 may be used by the AI model 128 to perform image reconstruction on an image that has been corrected for the identified abnormalities. More specifically, the AI model 128 may be configured to use the synthetic simulated data from step 215 to learn the inverse solution (e.g., to the forward problem defined at step 210) with parametric space coverage. Therefore, the AI model 128 provides a fundamental reconstruction method configured to resolve variously caused abnormalities.

At step 225, image reconstruction is performed. That is, step 225 may include reconstructing an output image based on the image data with the corrected abnormality.

Referring to FIG. 3, step 210 of method 200 (e.g., identifying the defects or artifacts) is shown in greater detail. As shown in FIG. 3, identifying the defects or artifacts identified at step 210 may include identifying a hardware-caused defect/artifact 211, identifying a software-caused defect/artifact 212, and/or identifying a patient-caused defect/artifact 213.

In some embodiments, the hardware-caused defect/artifact 211 may include a malfunctioning of a hardware component included in the medical imaging system 100 (e.g., the imaging unit 110, the processing circuit 120, etc.). That is, the hardware-caused defect/artifact 211 may be caused by misaligned detectors or components (e.g., where the medical imaging system 100 is a CT imaging system, a PET imaging system, or a SPECT imaging system), degraded detectors, magnetic field inhomogeneity (e.g., where the medical imaging system 100 is an MR imaging system), X-ray tube issues (e.g., where the medical imaging system 100 is a CT imaging system, the X-ray tube issues including reduced tube output, irregular radiation emission, etc.), mechanical instabilities (e.g., table vibration, gantry wobble, unstable transducer positioning, etc.), ultrasound probe damage (e.g., where the medical imaging system 100 is an ultrasound imaging system, the ultrasound probe damage comprising cracked or damaged piezoelectric crystals in the ultrasound probe, etc.), power supply fluctuations (e.g., inconsistent or insufficient power supply), cooling system failures (e.g., causing overheating in X-ray tubes or magnets, etc.), coil or antenna malfunction (e.g., where the medical imaging system 100 is an MR imaging system), cable wear or loose connections, insufficient resolution or bandwidth, aging or outdated components, motion or vibration sensitivity, environmental factors (e.g., temperature fluctuations, electromagnetic interference, mechanical shocks, etc.), and so on. For example, and as shown in FIG. 3, the hardware-caused defect/artifact 211 may be caused by a broken detector element 211a, a small field of view 211b, noise from a detector or digital signal processing 211c, and so on.

In some embodiments, the software-caused defect/artifact 212 may include a malfunctioning of a software component included in the medical imaging system 100 (e.g., the imaging unit 110, the processing circuit 120, etc.). That is, the software-caused defect/artifact 212 may be caused by reconstruction algorithm errors (e.g., where the medical imaging system 100 is a CT imaging system, an MR imaging system, a PET imaging system, a SPECT imaging system, etc.), improper calibration parameters, noise reduction and filtering issues, incorrect settings or configuration (e.g., slice thickness, field of view, imaging sequences, etc.), data transmission or processing delays, inadequate motion correction (e.g., where the medical imaging system 100 is an MR imaging system, an ultrasound imaging system, etc.), faulty integration with AI or other advanced tools, outdated or incompatible software, system crashes or data loss, and so on. For example, and as shown in FIG. 3, the software-caused defect/artifact 212 may be caused by a failed filtered back projection 212a or a flexible field of view with super-resolution imaging 212b.

The patient-caused defect/artifact 213 refers to a defect/artifact caused by a patient-related factor. That is, the patient-caused defect/artifact 213 may be caused by patient motion (e.g., where the medical imaging system 100 is a CT imaging system, an MR imaging system, an ultrasound imaging system, etc.), body size and composition (e.g., where the medical imaging system 100 is a CT imaging system, an MR imaging system, an ultrasound imaging system, etc.), breathing patterns such as irregular or deep breathing (e.g., where the medical imaging system 100 is a CT imaging system, an MR imaging system, etc.), inconsistent positioning, implants or medical devices (e.g., pacemakers, joint replacements, dental implants or hardware, etc.), contrast agent distribution (e.g., inconsistent or inadequate distribution of the contrast agent within the body due to patient factors such as poor blood flow or renal issues), hydration or tissue density, health conditions (e.g., muscle atrophy, bone density loss, arthritis, scoliosis, pulmonary diseases, obesity, neurological disorders, etc.), skin and soft tissue variability (e.g., wounds, tattoos, scarring, excessive tissue swelling, etc.), age-related factors, patient anxiety or claustrophobia, contrast sensitivity (e.g., due to underlying conditions, medications, etc.), and so on. For example, and as shown in FIG. 3, the patient-caused defect/artifact 213 may be caused by fluids 213a, materials and/or substances applied on a body to enhance imaging results 213b, a dose 213c, or anatomical motion 213d.

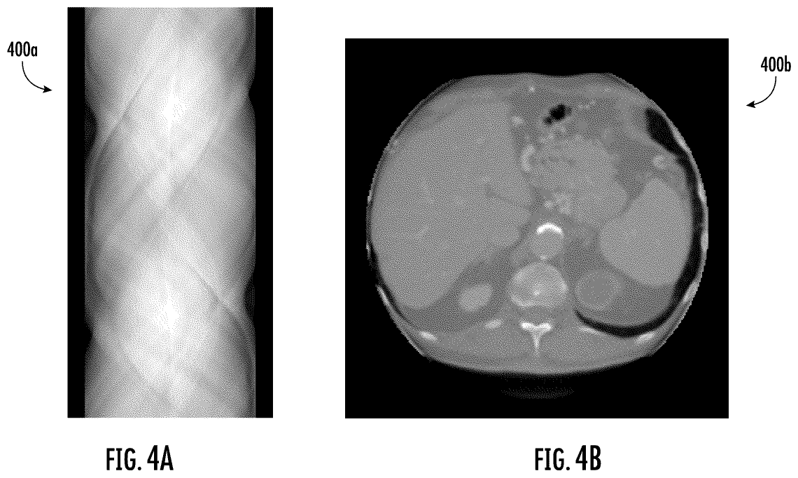

Referring to FIGS. 4A and 4B, a sinogram 400a and a CT image 400b are shown, respectively, depicting a hardware-caused defect. More specifically, the defect represented by the sinogram 400a and corresponding CT image 400b in FIGS. 4A and 4B may be caused by a limited field of view. Therefore, the forward problem and cause of the defect may be identified (e.g., at step 210 of method 200) as a limited field of view of the imaging unit 110 (e.g., a hardware limitation). In this way, the data synthesis and generation (e.g., step 215 of method 200) for the identified forward problem may include actual data augmentation and synthetic data with the forward problem being systematically generating CT images with the limited field of view (e.g., smaller detector, thinner sinogram with fewer detectors to simulate the limited field of view images). Moreover, with actual CT images, an image pair with the limited field of view can be synthesized by reducing the number of detectors for Radon transformation and/or by truncating the edge of the sinogram by a ratio.

Therefore, the AI model 128 may be trained to obtain a full field of view image (e.g., x) by observing the truncated sinogram (e.g., y) or the sinogram with fewer detector elements. In this instance, where y=Ax and A is known (e.g., the forward CT projection), the following objective function may be solved iteratively by a dual-domain unrolled network (e.g., the AI model 128) to obtain the full field of view image:

$$\hat{x} = {arg}_{x} min J ( x ) = \frac{λ}{2} {‖ Ax - y ‖}_{2}^{2} + R ( x )$$

where R(x) is a regulatory term in different forms per design. The iterative unrolled network is the formulated as below:

$${x}_{t + 1} = {x}_{t} - {λ}_{t} {A}^{- 1} ( {Ax}_{t} - y ) + Ψ ( {x}_{t} )$$

where t is the phase of unroll operation, and Ψ is the learnable regularization term with gradient. To simplify the training, the regularization term may be formulated as an L1 sparse term. For example, the Iterative Shrinkage-Thresholding Algorithm (ISTA) may be used to formulate the regularization term as the L1 sparse term.

As a brief overview, the ISTA is an optimization method used for solving sparse recovery problems, particularly in the context of signal processing and compressed sensing. It is designed to solve linear inverse problems where the goal is to recover a sparse signal from incomplete or noisy measurements. ISTA operates by iteratively applying two main steps: shrinkage and thresholding. In the first step, it performs a gradient descent update to move toward a solution. In the second step, the algorithm applies a soft thresholding operator, which encourages sparsity by shrinking small coefficients to zero while preserving larger ones. This iterative process continues until convergence, resulting in a solution that has a minimal number of non-zero components. ISTA may be used in various implementations such as image reconstruction, denoising, and sparse coding.

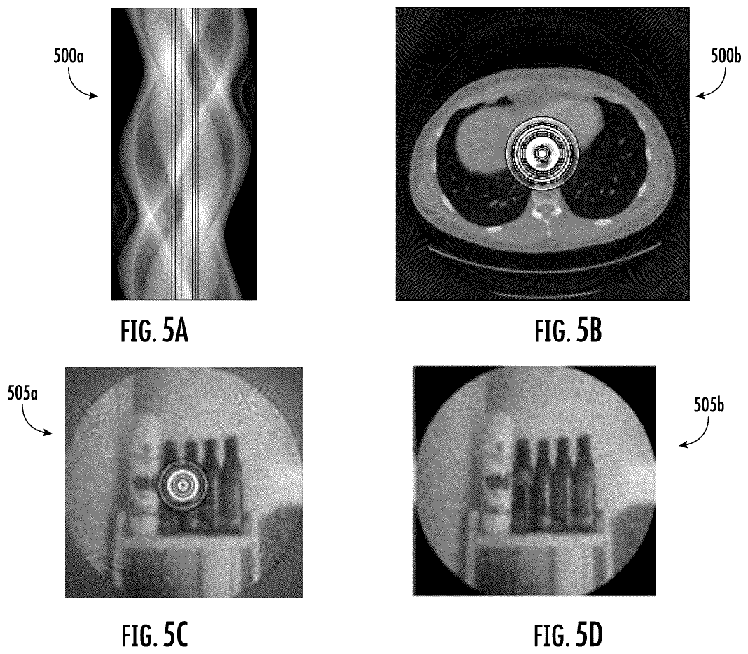

Referring to FIGS. 5A and 5B, a sinogram 500a and corresponding CT image 500b are shown, respectively, depicting a defect caused by malfunctioning detector points. Referring to FIGS. 5C and 5D, a first natural image 500a and a second natural image 500b are shown, respectively. More specifically, the first natural image 505a is configured to simulate the defect depicted in the sinogram 500a and the CT image 500b, while the second natural image 505b is corrected for the defect. In this instance, the forward problem and cause of the defect is defined as a hardware limitation (e.g., malfunctioning detector elements on a CT scanner). In this way, the data synthesis and generation (e.g., step 215 of method 200) for the identified forward problem may include using actual data augmentation and natural image data with the forward problem being systematically generating CT images with the defective or malfunctioning detector bins. If there are insufficient and/or improper CT images for simulation during such an implementation, however, natural images (e.g., the first natural image 505a and the second natural image 505b) may be used to simulate the defect, as shown in FIG. 5C.

Therefore, the AI model 128 may be trained to obtain a deadpoint-free image (e.g., x) by observing the broken sinogram (e.g., y). In this instance, where y=Ax and A is known (e.g., the forward CT projection), the following objective function may be solved iteratively by a dual-domain unrolled network (e.g., the AI model 128) to obtain the defect-free image:

$$\hat{x} = {arg}_{x} min J ( x ) = \frac{λ}{2} {‖ Ax - y ‖}_{2}^{2} + R ( x )$$

where R(x) is a regulatory term in different forms per design. The iterative unrolled network is the formulated as below:

$${x}_{t + 1} = {x}_{t} - {λ}_{t} {A}^{- 1} ( {Ax}_{t} - y ) + Ψ ( {x}_{t} )$$

where t is the phase of unroll operation, and Ψ is the learnable regularization term with gradient. To simplify the training, the regularization term may be formulated as an L1 sparse term via Iterative Shrinkage-Thresholding Algorithm (ISTA).

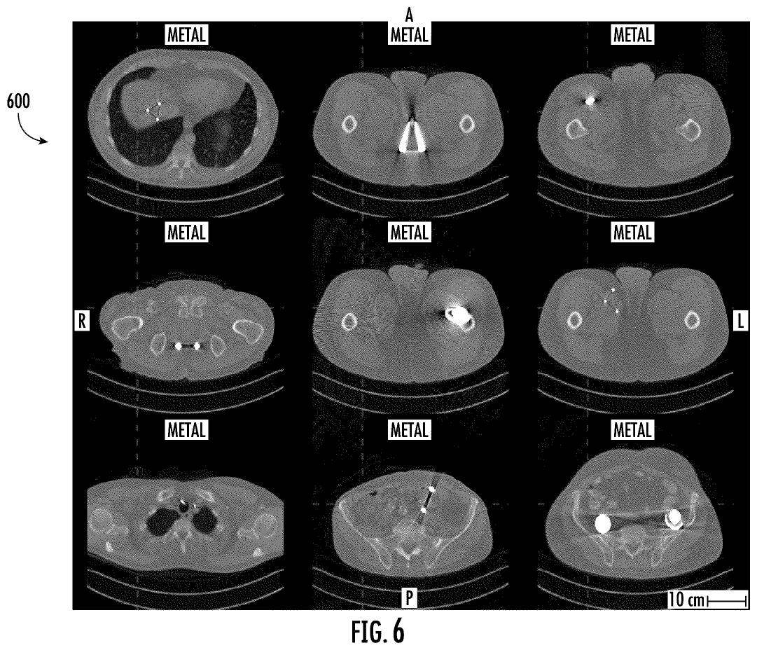

Referring to FIG. 6, a plurality of simulated CT images 600 depicting a metal artifact is shown. In this instance, the forward problem and cause of the defect may be identified (e.g., at step 210 of method 200) as a failed filtered back projection (e.g., a software limitation) due to the discontinuity caused by the metal within the patient being imaged (e.g., a patient limitation). That is, the cause of the defect depicted in FIG. 6 may be the software limitation and the patient limitation. In this way, the data synthesis and generation (e.g., step 215 of method 200) for the identified forward problem may include actual data augmentation and synthetic data with the forward problem being systematically generating CT images depicting the metal implant (e.g., the plurality of simulated CT images 600), which causes metal artifacts in a sinogram. More specifically, the CT images with the metal implant may be simulated using an energy band analysis of the CT scanning in image domain, per soft-tissue, bone, and metal.

Therefore, the AI model 128 may be trained to obtain a metal artifact free image (e.g., x) by observing the sinogram (e.g., y). In this instance, where y=Ax and A is known (e.g., the forward CT projection), the following objective function may be solved iteratively by a dual-domain unrolled network (e.g., the AI model 128) to obtain the defect-free image:

$$\hat{x} = {arg}_{x} min J ( x ) = \frac{λ}{2} {‖ Ax - y ‖}_{2}^{2} + R ( x )$$

where R(x) is a regulatory term in different forms per design. The iterative unrolled network is the formulated as below:

$${x}_{t + 1} = {x}_{t} - {λ}_{t} {A}^{- 1} ( {Ax}_{t} - y ) + Ψ ( {x}_{t} )$$

where t is the phase of unroll operation, and Ψ is the learnable regularization term with gradient. To optimize the above problem with high accuracy, the Ψ may be designed using wavelet transformation and a swin-transformer to properly reduce and learn the pattern of artifacts.

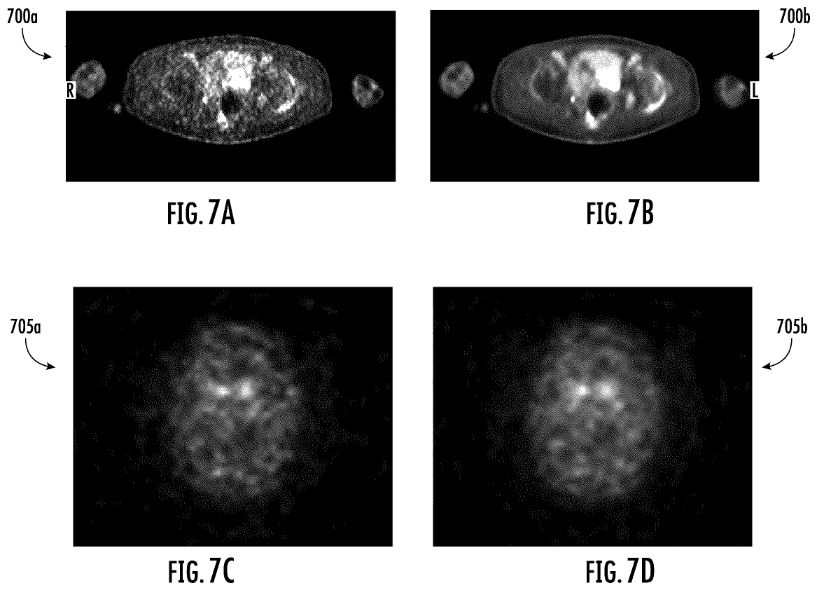

Referring to FIGS. 7A and 7B, a low dose PET image 700a and a full dose PET image 700b are shown, respectively. Referring to FIGS. 7C and 7D, a low dose SPECT image 505a and a full dose SPECT image 505b are shown, respectively. In this instance, the forward problem and cause of the defect is defined as a low radiation dose of the radiation source and a scanner (e.g., imaging unit 110) having high noise (e.g., a hardware limitation and a patient limitation). In this way, the data synthesis and generation (e.g., step 215 of method 200) for the identified forward problem may include using actual data augmentation and synthetic data with the forward problem being systematically generating the low dose images (e.g., as shown in FIGS. 7A and 7C) in a sinogram simulation. The low dose images may be simulated by manipulating the sinogram using a physical-driven sampling method or definition.

Therefore, the AI model 128 may be trained to obtain a noise-free image (e.g., x) by observing the low-dose sinogram (e.g., y). In this instance, where y=Ax and A is known (e.g., the forward PET/SPECT projection), the following objective function may be solved iteratively by a dual-domain unrolled network (e.g., the AI model 128) to obtain the defect-free image:

$$\hat{x} = {arg}_{x} min J ( x ) = \frac{λ}{2} {‖ Ax - y ‖}_{2}^{2} + R ( x )$$

where R(x) is a regulatory term in different forms per design. The iterative unrolled network is the formulated as below:

$${x}_{t + 1} = {x}_{t} - {λ}_{t} {A}^{- 1} ( {Ax}_{t} - y ) + Ψ ( {x}_{t} )$$

where t is the phase of unroll operation, and Ψ is the learnable regularization term with gradient. To simplify the training, the regularization term may be formulated as an L1 sparse term. For example, and as mentioned above, the Iterative Shrinkage-Thresholding Algorithm (ISTA) may be used to formulate the regularization term as the L1 sparse term.

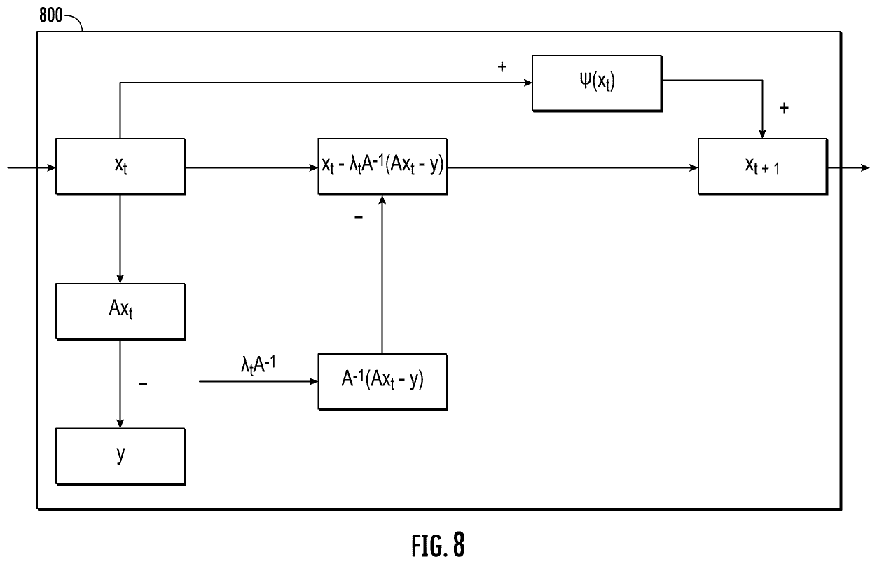

Referring to FIG. 8, a diagram of an unrolled model 800 used to perform the operations described herein is shown. In some embodiments, the unrolled model 800 is an example of the AI model 128 used to perform the operations described herein. That is, for the medical imaging system 100 described herein, the medical imaging (e.g., scanning) step can be formulated as:

$$y = Ax + n$$

where x is the object to be imaged (e.g., a patient), A is the scan system, and N is the noise. A refers to a linear, discrete forward projection for CT, ultrasound, MR, PET, or SPECT, depending on an implementation of the medical imaging system 100. The noise N may include quantum noise, electronic noise, and so on. Furthermore, Y is the observed data in scanning domain or image domain.

When solving for y=Ax+n, the solution may be determined such that an estimated x is:

$$\hat{x} = {arg}_{x} min J ( x ) = \frac{λ}{2} {‖ Ax - y ‖}_{2}^{2} + R ( x )$$

where R(x) is a regularization term (e.g., norm-1, norm-2, any non-convex differentiable functions per question, etc.). To solve for the above problem, the formula may be solved iteratively using an unrolling method:

$${x}_{t + 1} = {x}_{t} - {λ}_{t} {A}^{- 1} ( {Ax}_{t} - y ) + Ψ ( {x}_{t} )$$

where A is the previous linear discrete forward model and Ψ is the learnable regularization term with gradient, which can be approximated by any form of AI model estimation.

For a projection-based problem in CT, SPECT, and/or PET, A is the scanning process, (e.g., Radon projection of the target x), while inverse A may be filtered back projection, as the minor differences can be compensated by estimating Ψ(xₜ). In MR imaging or other transformation, A can be the Fourier transformation between image space and k-space, or other scanning space used in the imaging method. Therefore, with the formula:

$${x}_{t + 1} = {x}_{t} - {λ}_{t} {A}^{- 1} ( {Ax}_{t} - y ) + Ψ ( {x}_{t} )$$

the unrolled model 800 as shown in FIG. 8 may be designed as a general approach to solve the defects described herein, rather than as specific implementation to solve a specific type of defect. In this way, the unrolled model 800 may be a foundation model that is trained to solve any defects or artifacts in image data (e.g., due to the defects or artifacts being known).

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As utilized herein, terms of degree such as “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to any precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that terms such as “exemplary,” “example,” and similar terms, as used herein to describe various embodiments, are intended to indicate that such embodiments are possible examples, representations, or illustrations of possible embodiments, and such terms are not intended to connote that such embodiments are necessarily extraordinary or superlative examples.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any element on its own or any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the drawings. It should be noted that the orientation of various elements may differ according to other exemplary embodiments, and that such variations are intended to be encompassed by the present disclosure.

As used herein, terms such as “engine” or “circuit” may include hardware and machine-readable media storing instructions thereon for configuring the hardware to execute the functions described herein. The engine or circuit may be embodied as one or more circuitry components including, but not limited to, processing circuitry, network interfaces, peripheral devices, input devices, output devices, sensors, etc. In some embodiments, the engine or circuit may take the form of one or more analog circuits, electronic circuits (e.g., integrated circuits (IC), discrete circuits, system on a chip (SOCs) circuits, etc.), telecommunication circuits, hybrid circuits, and any other type of circuit. In this regard, the engine or circuit may include any type of component for accomplishing or facilitating achievement of the operations described herein. For example, an engine or circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

An engine or circuit may be embodied as one or more processing circuits comprising one or more processors communicatively coupled to one or more memory or memory devices. In this regard, the one or more processors may execute instructions stored in the memory or may execute instructions otherwise accessible to the one or more processors. The one or more processors may be constructed in a manner sufficient to perform at least the operations described herein. In some embodiments, the one or more processors may be shared by multiple engines or circuits (e.g., engine A and engine B, or circuit A and circuit B, may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more suitable processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given engine or circuit or components thereof may be disposed locally (e.g., as part of a local server, a local computing system, etc.) or remotely (e.g., as part of a remote server such as a cloud based server). To that end, engines or circuits as described herein may include components that are distributed across one or more locations.

An example system for providing the overall system or portions of the embodiments described herein might include one or more computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

Although the drawings may show and the description may describe a specific order and composition of method steps, the order of such steps may differ from what is depicted and described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions, and arrangement of the embodiments without departing from the scope of the present disclosure as expressed in the appended claims.

What is claimed is:

1. A system configured to train an artificial intelligence model, the system comprising:
a processing circuit comprising a processor coupled to a memory device storing instructions thereon that, when executed, cause the processing circuit to perform operations comprising:
identifying a cause of an abnormality within image data;
generating synthetic data based on the cause of the abnormality;
training the artificial intelligence model using the synthetic data; and
performing, using the artificial intelligence model, reconstruction of the image data.

2. The system of claim 1, wherein the system is configured to generate the image data regarding a subject, and wherein the system comprises one or more hardware components and one or more software components.

3. The system of claim 2, wherein the cause of the abnormality is at least one of the one or more hardware components, the one or more software components, or the subject.

4. The system of claim 1, wherein the synthetic data comprises training data pairs, the training data pairs corresponding to an imaging unit domain and an image domain.

5. The system of claim 4, wherein the training data pairs further comprise at least one of a natural image or a synthetic image.

6. The system of claim 1, wherein the synthetic data is generated based on at least one of a physical, chemical, mathematical, or biological principle.

7. The system of claim 1, wherein the image data is generated by at least one of a computed tomography imaging system, an ultrasound imaging system, a magnetic resonance imaging system, a positron emission tomography imaging system, or a single-photon emission computerized tomography imaging system.

8. The system of claim 7, wherein the operations further comprise:
retrieving, from a database, historical information relating to the at least one of the computed tomography imaging system, the ultrasound imaging system, the magnetic resonance imaging system, the positron emission tomography imaging system, or the single-photon emission computerized tomography imaging system,
wherein the cause of the abnormality is identified based on the historical information.

9. The system of claim 1, wherein the abnormality comprises at least one of an artifact, noise, a low-resolution, or a reduced field of view in the image data.

10. A medical imaging system comprising:
an imaging unit; and
a processing circuit comprising a processor coupled to a memory device storing instructions thereon that, when executed, cause the processing circuit to perform operations comprising:
receiving image data of a subject, the image data obtained using the imaging unit;
identifying an abnormality within the image data;
determining a cause of the abnormality within the image data; and
correcting, using an artificial intelligence model, the abnormality based on the cause of the abnormality, wherein the artificial intelligence model is configured to correct for abnormalities within the image data that are respectively caused by one or more hardware components, by one or more software components, and by the subject.

11. The medical imaging system of claim 10, wherein at least one of the imaging unit or the processing circuit further comprises the one or more hardware components, and wherein at least one of the imaging unit or the processing circuit further comprises the one or more software components.

12. The medical imaging system of claim 10, wherein the operations further comprise generating synthetic data based on the abnormality, and training the artificial intelligence model using the synthetic data.

13. The medical imaging system of claim 10, wherein the medical imaging system further comprises a database, the database comprising historical information relating to the medical imaging system.

14. The medical imaging system of claim 13, wherein the processing circuit is configured to determine the cause of the abnormality based on the historical information relating to the medical imaging system.

15. The medical imaging system of claim 10, wherein the medical imaging system is at least one of a computed tomography imaging system, an ultrasound imaging system, a magnetic resonance imaging system, a positron emission tomography imaging system, or a single-photon emission computerized tomography imaging system.

16. A method for performing medical image reconstruction, the method comprising:
receiving, by a processing circuit of a medical imaging system, image data obtained using the medical imaging system;
identifying, by the processing circuit, an abnormality within the image data;
determining, by the processing circuit, a cause of the abnormality within the image data;
correcting, by the processing circuit using an artificial intelligence model, the abnormality based on the cause of the abnormality, wherein the artificial intelligence model is configured to correct for abnormalities within the image data that are respectively caused by one or more hardware components, by one or more software components, and by a subject; and
reconstructing an output image based on the image data with the corrected abnormality.

17. The method of claim 16, wherein the cause of the abnormality comprises at least one of the one or more hardware components, the one or more software components, or the subject.

18. The method of claim 16, wherein the artificial intelligence model is configured to correct for the abnormalities using training data pairs, the training data pairs corresponding to an imaging unit domain and an image domain.

19. The method of claim 16, wherein the processing circuit is configured to determine the cause of the abnormality based on historical information relating to the medical imaging system.

20. The method of claim 16, further comprising generating synthetic data based on the abnormality, and training the artificial intelligence model using the synthetic data.
